(19) United States
(12) Patent Application Publication
(10) Pub. No.: US 2025/0010564 A1
(43) Pub. Date: Jan. 9, 2025

(54) PRESS MACHINE AND METHOD FOR DETECTING ABNORMALITY IN PRESS MACHINE

(71) Applicant: AIDA ENGINEERING, LTD., Kanagawa (JP)

(72) Inventor: Yoshiki YANAGIHARA, Sagamihara-shi (JP)

(21) Appl. No.: 18/762,487

(22) Filed: Jul. 2, 2024

(30) Foreign Application Priority Data
Jul. 6, 2023 (JP) 2023-111401

(51) Int. Cl. B30B 15/00; B30B 15/02

(52) U.S. Cl. CPC B30B 15/0094; B30B 15/02

(57) ABSTRACT

A press machine includes: a detection unit that detects a load value during press process on a material to be processed; a storage unit that stores the load value detected by the detection unit in association with identification information of a mold attached to the press machine during detection of the load value; a calculation unit that calculates a position of a load center acting on the press machine based on the stored load value, calculates the calculated position of the load center as an eccentric amount from a center of the press machine to obtain an eccentric load, and generates distribution data of the eccentric load for each mold; a determination unit that determines an abnormality based on the eccentric load obtained on the basis of the load value detected by the detection unit and the distribution data of the eccentric load corresponding to the mold attached to the press machine during detection of the load value; and a notification unit that notifies an abnormality based on a determination result of the determination unit.

### CROSS-REFERENCE TO RELATED APPLICATION

Japanese Patent Application No. 2023-111401, filed on Jul. 6, 2023, is hereby incorporated by reference in their entirety.

### BACKGROUND OF THE INVENTION

The present invention relates to a press machine and an abnormality detection method for a press machine.

Conventionally, there is known a method of detecting a press load during press process, calculating an eccentric amount based on the detected press load, and determining that there is a press abnormality in a case where the detected press load exceeds a press load allowable amount based on the calculated eccentric amount (a range of an allowable eccentric load diagram defined by a manufacturer for each press) (see JP-A-2016-209887).

The conventional method described above consists in a function for protecting the press machine. On the other hand, a user of the press machine needs to manage condition of a mold and accuracy of the molded product in addition to press protection, and to detect potential incidents such as an abnormality in the mold and a defect in the accuracy of the product at an early stage and take countermeasures against such incidents. Since the abnormality in the mold and the defect in the accuracy of the product mainly occur within the range of the allowable eccentric load diagram, the conventional method faces difficulties in detecting the abnormality in the mold, the defect in the accuracy of the product, or the like.

### SUMMARY OF THE INVENTION

The present invention can provide a press machine and an abnormality detection method for a press machine, which can detect an abnormality in a mold.

A press machine according to a first aspect of the present invention includes:
a detection unit that detects a load value during press process on a material to be processed;
a storage unit that stores the load value detected by the detection unit in association with identification information of a mold attached to the press machine during detection of the load value;
a calculation unit that calculates a position of a load center acting on the press machine based on the stored load value, calculates the position of the load center as an eccentric amount from a center of the press machine to obtain an eccentric load, and generates distribution data of the eccentric load for each mold;
a determination unit that determines an abnormality based on the eccentric load obtained on the basis of the load value detected by the detection unit and the distribution data of the eccentric load corresponding to the mold attached to the press machine during detection of the load value; and
a notification unit that notifies an abnormality based on a determination result of the determination unit.

An abnormality detection method for a press machine according to a second aspect of the present invention includes:
a detection step of detecting a load value when press process is performed on a material to be processed;
a storage step of storing the load value detected in the detection step in association with identification information of a mold attached to the press machine during detection of the load value;
a calculation step of calculating a position of a load center acting on the press machine based on the stored load value, calculating the position of the load center as an eccentric amount from a center of the press machine to obtain an eccentric load, and generating distribution data of the eccentric load for each mold;
a determination step of determining an abnormality based on the eccentric load obtained on the basis of the load value detected in the detection step and the distribution data of the eccentric load corresponding to the mold attached to the press machine during detection of the load value; and
a notification step of notifying an abnormality based on a determination result of the determination step.

### BRIEF DESCRIPTION OF THE DRAWINGS

FIG. 1 is a diagram illustrating an example of a configuration of a press machine according to one embodiment of the present invention.

FIG. 2 is a diagram illustrating an example of a load sensor.

FIG. 3 is a flowchart illustrating a flow of process of generating distribution data of an eccentric load.

FIG. 4 is a diagram illustrating an example of a load value to be stored.

FIG. 5 is a diagram illustrating an example of display of an eccentric load data group corresponding to the same mold.

FIG. 6 is a diagram illustrating an example of display of an eccentric load data group corresponding to the same mold.

FIG. 7 is a diagram illustrating an example of display of an eccentric load data group corresponding to the same mold.

FIG. 8 is a diagram illustrating an example of display of an eccentric load data group corresponding to the same mold.

FIG. 9 is a diagram illustrating an example of display of an eccentric load data group corresponding to the same mold.

FIG. 10 is a diagram illustrating an example of display of an eccentric load data group corresponding to the same mold and waveform data of a load value.

FIG. 11 is a flowchart illustrating a flow of process of detecting an abnormality.

FIG. 12 is a diagram for explaining an abnormality detection method according to one embodiment of the present invention.

FIG. 13 is a diagram illustrating an example of a change in distribution of an eccentric load.

### DETAILED DESCRIPTION OF THE INVENTION

(1) A press machine according to one embodiment of the present invention includes:
a detection unit that detects a load value during press process on a material to be processed;
a storage unit that stores the load value detected by the detection unit in association with identification information of a mold attached to the press machine during detection of the load value;
a calculation unit that calculates a position of a load center acting on the press machine based on the stored load value, calculates the position of the load center as an eccentric amount from a center of the press machine to obtain an eccentric load, and generates distribution data of the eccentric load for each mold;
a determination unit that determines an abnormality based on the eccentric load obtained on the basis of the load value detected by the detection unit and the distribution data of the eccentric load corresponding to the mold attached to the press machine during detection of the load value; and
a notification unit that notifies an abnormality based on a determination result of the determination unit.

Further, an abnormality detection method for a press machine according to one embodiment of the present invention includes:
a detection step of detecting a load value during press process on a material to be processed;
a storage step of storing the load value detected in the detection step in association with identification information of a mold attached to the press machine during detection of the load value;
a calculation step of calculating a position of a load center acting on the press machine based on the stored load value, calculating the position of the load center as an eccentric amount from a center of the press machine to obtain an eccentric load, and generating distribution data of the eccentric load for each mold;
a determination step of determining an abnormality based on the eccentric load obtained on the basis of the load value detected in the detection step and the distribution data of the eccentric load corresponding to the mold attached to the press machine during detection of the load value; and
a notification step of notifying an abnormality based on a determination result of the determination step.

According to the above embodiment, the load value detected by the detection unit is stored in association with the identification information of the mold attached to the press machine during detection, the position of the load center acting on the press machine is calculated from the stored load value, the calculated position of the load center is calculated as the eccentric amount from the center of the press machine to obtain the eccentric load, the distribution data of the eccentric load for each mold is generated, and the abnormality is determined based on the eccentric load obtained on the basis of the load value detected by the detection unit and the distribution data of the eccentric load corresponding to the mold attached to the press machine during detection of the load value, whereby the abnormality in the mold can be detected. Here, the load center means the center of gravity of the load. Further, the center of the press machine means a center position of a slide on a plane orthogonal to a direction (a vertical direction) in which the slide moves.

(2) In the press machine according to the above embodiment,
in the calculation unit,
a plurality of eccentric load data arbitrarily selected by a user among an eccentric load data group corresponding to the same mold may be defined as distribution data of the eccentric load corresponding to the mold.

In the abnormality detection method for a press machine according to the above embodiment,
in the calculating step,
a plurality of eccentric load data arbitrarily selected by a user among an eccentric load data group corresponding to the same mold may be defined as distribution data of the eccentric load corresponding to the mold.

(3) In the press machine according to the above embodiment,
a display control unit that causes a display unit to display an image in which an eccentric load data group corresponding to the same mold is plotted may be further included.

In the abnormality detection method for a press machine according to the above embodiment,
a display control step of causing a display unit to display an image in which an eccentric load data group corresponding to the same mold is plotted may be further included.

(4) In the press machine according to the above embodiment,
the display control unit
may cause the display unit to display waveform data of a load value corresponding to data arbitrarily selected by a user among the data group displayed on the display unit.

In the abnormality detection method for a press machine according to the above embodiment,
in the display control step,
waveform data of a load value corresponding to data arbitrarily selected by a user among the data group displayed on the display unit may be displayed on the display unit.

Hereinafter, embodiments of the present invention will be described in detail with reference to the drawings.

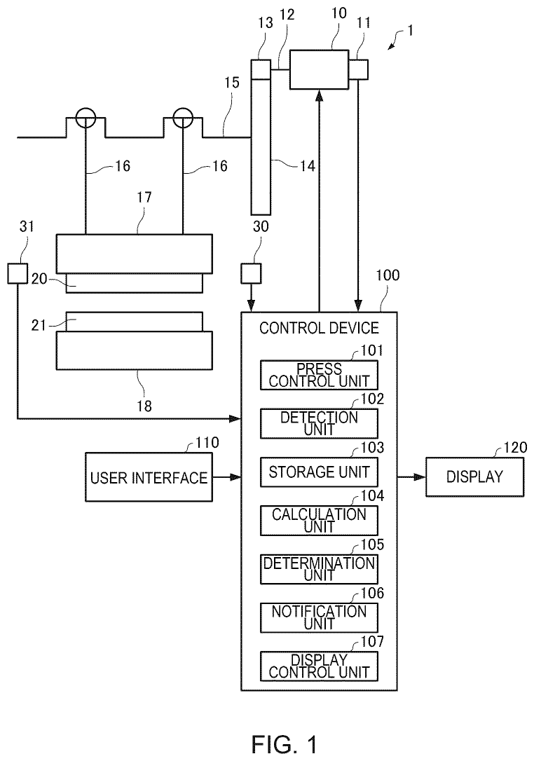

FIG. 1 is a diagram illustrating an example of a configuration of a press machine (a servo press) according to the present embodiment. A press machine 1 converts rotation of a servomotor 10 into a vertical reciprocating motion (a linear reciprocating motion, an elevating and lowering motion) of a slide 17 by an eccentric mechanism that converts a rotational motion into a linear motion, and performs press process on a material to be processed using the vertical reciprocating motion of the slide 17. The press machine 1 includes a servomotor 10, an encoder 11, a drive shaft 12, a drive gear 13, a main gear 14, a crankshaft 15, a connecting rod 16, a slide 17, a bolster 18, a control device 100, a user interface 110 (an action unit), and a display 120 (a display unit). The press machine is not limited to a servo press, and may be, for example, a mechanical press using a flywheel or a direct-acting type press using a ball screw. In this case, the encoder may be provided at a shaft end of the crankshaft 15 or of the ball screw.

The drive shaft 12 is connected to a rotating shaft of the servomotor 10, and the drive gear 13 is connected to the drive shaft 12. The main gear 14 is meshed with the drive gear 13, the crankshaft 15 is connected to the main gear 14, and the connecting rod 16 is connected to the crankshaft 15. Rotating shafts such as the drive shaft 12 and the crankshaft 15 are supported by bearings (not illustrated) appropriately provided. An eccentric mechanism is formed between the crankshaft 15 and the connecting rod 16. This eccentric mechanism allows the slide 17 connected to the connecting rod 16 to move upwards and downwards relative to the bolster 18 on a stationary side. Here, the press machine 1 is a two-point drive press machine in which the crankshaft 15 and the slide 17 are connected by two connecting rods 16 that also function as suspensions. An upper mold 20 is attached to the slide 17, and a lower mold 21 is attached to the bolster 18.

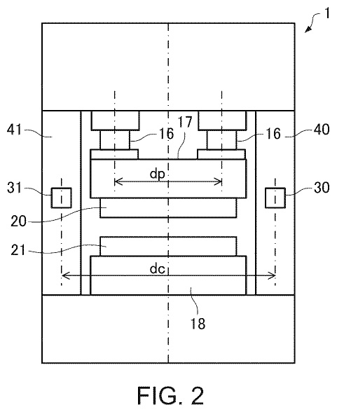

The press machine 1 includes a right load sensor 30 and a left load sensor 31 for detecting a load value during press process on a material to be processed for each press cycle. As shown in FIG. 2, the right load sensor 30 is a strain gauge attached to a right column 40 (a right side frame) of the press machine 1, and the left load sensor 31 is a strain gauge attached to a left column 41 (a left side frame) of the press machine 1. Note that, as the right load sensor 30 and the left load sensor 31, a pressure sensor provided in a hydraulic chamber formed in the slide 17 may be used. Output data of the right load sensor 30 and the left load sensor 31 (voltage signals of the strain gauge or pressure sensor) are input to the control device 100.

The control device 100 includes a press control unit 101, a detection unit 102, a storage unit 103, a calculation unit 104, a determination unit 105, a notification unit 106, and a display control unit 107. Note that, the control device 100 may be divided into an independent device that controls the press machine and includes the press control unit 101, the display control unit 107, the user interface 110, and the display 120, and an independent device that detects a load and includes the detection unit 102, the storage unit 103, the calculation unit 104, the determination unit 105, the notification unit 106, the display control unit 107, the user interface 110, and the display 120. In that case, the output data of the right load sensor 30 and the left load sensor 31 are directly input to the device that detects the load. Further, mode information of the press machine such as crank angle information is input from the device that controls the press machine to the device that detects the load as necessary.

The detection unit 102 receives data output from the right load sensor 30 and data output from the left load sensor 31 for each press cycle, converts the received data based on calibration data stored in the storage unit 103, and detects the converted data as load values (a right load value and a left load value) during press process. The calibration data indicates a relationship between the voltage signal and the load value, and is measured in advance using a load cell or the like and stored in the storage unit 103.

The storage unit 103 stores the load value detected by the detection unit 102 in association with identification information (a mold number) of a mold (the upper mold 20, the lower mold 21) attached to the slide 17 and the bolster 18 of the press machine 1 during detection of the load value.

The calculation unit 104 calculates the position of the load center acting on the press machine 1 based on the stored load value, calculates the calculated position of the load center as the eccentric amount from the center of the press machine 1 to obtain an eccentric load (a pair of a total load value and the eccentric amount), and generates distribution data of the eccentric load for each mold. The generated distribution data of the eccentric load for each mold is stored in the storage unit 103. Here, the calculation unit 104 may define a plurality of eccentric load data arbitrarily selected by the user among an eccentric load data group corresponding to the same mold as the distribution data (for example, normal distribution data) of the eccentric load corresponding to the mold.

The determination unit 105 determines an abnormality based on the eccentric load obtained by the calculation unit 104 on the basis of the load value detected by the detection unit 102 and the distribution data of the eccentric load corresponding to the mold attached to the slide 17 and the bolster 18 of the press machine 1 during detection of the load value.

The notification unit 106 notifies an abnormality based on the determination result of the determination unit 105. For example, in a case where the determination unit 105 determines that there is an abnormality, the notification unit 106 outputs information to that effect to the display 120.

The display control unit 107 causes the display 120 to display an image in which an eccentric load data group corresponding to the same mold is plotted on a graph. Further, the display control unit 107 may cause the display 120 to display waveform data of a load value corresponding to data arbitrarily selected by the user among the data group displayed on the display 120.

The user interface 110 is a known input means (for example, a mouse, a trackball, a keyboard, or the like) in which an action on the display 120 is possible. Further, the user interface 110 may be provided integrally with the display 120. In this case, an input means is displayed on the display 120.

The display 120 is a liquid crystal display (LCD) screen. Other known display devices (for example, organic Electro Luminescence (EL) or the like) may be used as the display 120. Further, a touch panel type display may be used as the display 120. As the touch panel, a touch panel of a known type such as a resistive film type, a capacitance type, a surface type capacitance type, or a projection type capacitance type can be used. As long as the display is of the touch panel type, an input action is achieved by directly touching the display 120 with a finger or a pen.

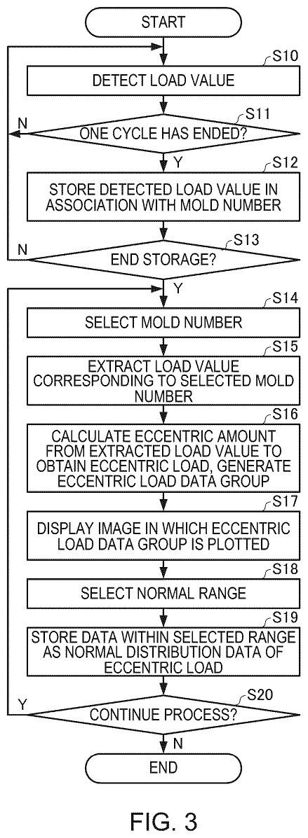

FIG. 3 is a flowchart illustrating a flow of process of generating distribution data of an eccentric load.

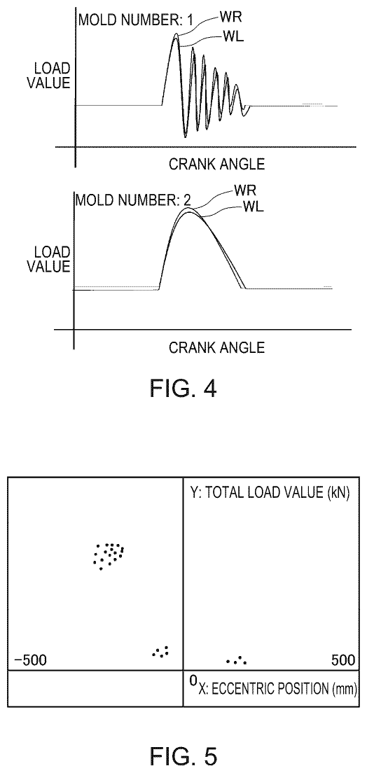

The process in steps S10 to S13 is a process of storing the load value. The load value is stored when a mold is attached to the press machine 1 for trial mode (a mold trial). First, the detection unit 102 receives the data output from the right load sensor 30 and the data output from the left load sensor 31, converts the received data based on the calibration data stored in the storage unit 103, and detects the converted data as a load value (step S10). Next, the control device 100 determines whether or not one cycle of press has ended based on information of a current crank angle (step S11), and in a case where one cycle has not ended (N in step S11), the process proceeds to step S10 and detection of the load value is continued. In a case where one cycle has ended (Y in step S11), the storage unit 103 assigns a time stamp to the detected load value for one cycle (waveform data of the right load and waveform data of the left load), and stores the load value in association with the mold number of the mold attached to the slide 17 and the bolster 18 of the press machine 1 during detection (step S12). FIG. 4 illustrates an example of a load value to be stored. As shown in FIG. 4, a load waveform WR for one cycle detected based on the data from the right load sensor 30 and a load waveform WL for one cycle detected based on the data from the left load sensor 31 are stored as load values in association with the mold number. Next, the control device 100 determines whether or not to end storage of the load value (step S13), and in a case where the storage is continued (N in step S13), the process proceeds to step S10, and thereafter, the load value is stored for each press cycle.

The process in steps S14 to S20 is a process of generating distribution data of the eccentric load. First, the control device 100 selects mold numbers based on an operation on the user interface 110 by the user (step S14). Next, the calculation unit 104 extract a load value corresponding to the selected mold number from the stored load value data (step S15), calculates the position of the load center acting on the press machine 1 from each extracted load value, calculates the calculated position of the load center as the eccentric amount from the center of the press machine 1 to obtain an eccentric load, and generates an eccentric load data group corresponding to the selected mold number (step S16). The eccentric amount (an eccentric position) can be calculated from a balance of moments based on the left and right load values when a waveform obtained by combining the waveforms of the left and right load values (the load waveform WR, the load waveform WL) shows a peak value and a distance between the right load sensor 30 and the left load sensor 31 (a distance de shown in FIG. 2). At a peak value of the waveform obtained by combining the left and right load waveforms, the eccentric amount is a positive value in a case where the right load is larger than the left load, a negative value in a case where the left load is larger than the right load, and its absolute value increases as a difference between the left and right loads increases. The eccentric load is data consisting of a pair of a peak value (the total load value) of a waveform obtained by combining the left and right load waveforms and an eccentric amount calculated from the left and right load values. Note that, in a case where pressure sensors provided in the hydraulic chamber formed in the slide 17 is used as the right load sensor 30 and the left load sensor 31, the eccentric amount is calculated based on the left and right load values when the waveform obtained by combining the waveforms of the left and right load values shows a peak value and the distance between the two connecting rods 16 (a point interval, a distance dp shown in FIG. 2).

Next, the display control unit 107 causes the display 120 to display an image in which the generated eccentric load data group is plotted (step S17). FIG. 5 illustrates an example of an image in which an eccentric load data group is plotted. The image shown in FIG. 5 is an image in which an eccentric load data group corresponding to the same mold (the selected mold number) is plotted on a graph (a scatter diagram) in which a horizontal axis (X axis) is the eccentric position (in mm) and a vertical axis (Y axis) is the total load value (in kN). In the figure, a black dot indicates one data of the eccentric load.

Next, the user selects a range to be defined as a normal distribution (a normal range) from the eccentric load data group displayed on the display 120 (step S18). The calculation unit 104 stores in the storage unit 103 the data within the selected range as normal distribution data of the eccentric load corresponding to the mold number selected in step S14 (step S19).

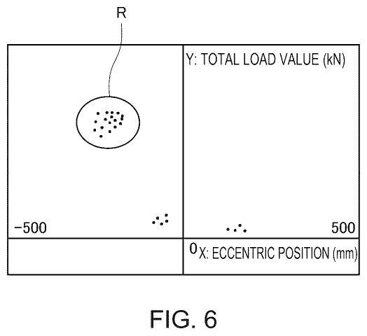

In step S18, since the eccentric load data group is likely to include data that can be abnormal, such as eccentric load data based on the load value detected during passage of the material into the mold and eccentric load data based on the load value detected during idling. Therefore, the user specifies as shown in FIG. 6 on the display 120 a range R representing a normal distribution among the eccentric load data group. The range R is specified by a method of specifying the range R on the display 120 using the user interface 110 or a method of specifying the range R by directly touching the display 120 with a finger or a pen. However, it is assumed that facing a task of specifying the range R, the user is confused in determining which data should be specified as the range R from a large number of data groups. Therefore, approaches for giving criteria for determination to the user will be described below.

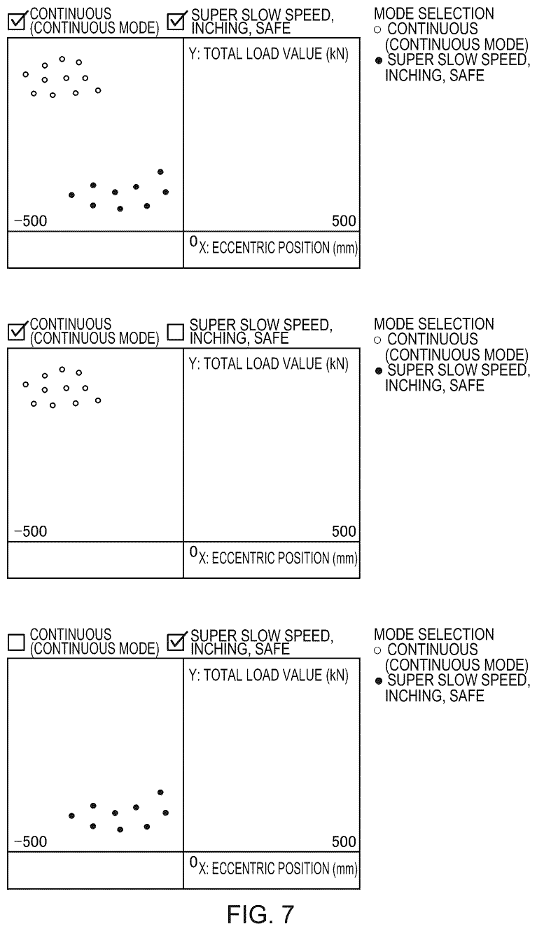

(Approach 1) As shown in FIG. 7, an eccentric load data group may be regrouped for display (under symbols) as in legend based on the operation information of the press machine 1. For example, when “continuous (continuous mode)” is selected by mode selection switches (superslow speed, inching, turning off, safe, continuous) during press cycle, the data group may appear on display in blank circles, as a data group obtained during steady-state mode of operation. On the other hand, as long as one of “superslow speed”, “inching (inching mode)”, or “safe (one safe cycle only)” is selected by the mode selection switches, the data group may appear on display in black circles, as a data group obtained during non-steady-state mode of operation such as passage of the material into the mold or idling. The operation information of the press machine 1 corresponding to each load value data, if associated in advance with the number of shots of the press machine 1 (the value of production number counter of the press machine 1) and stored in the storage unit 103, can also be associated with each eccentric load data. Further, a button may be provided on the screen for displaying or hiding the data group according to the state of the mode selection switch.

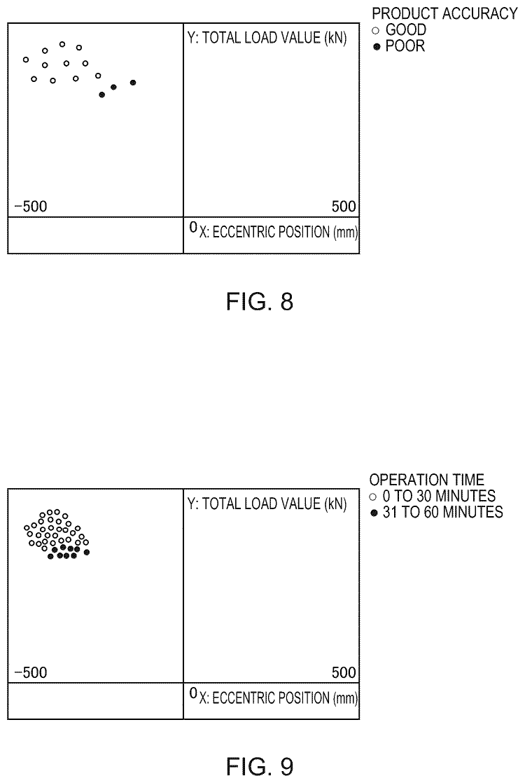

(Approach 2) As shown in FIG. 8, an eccentric load data group may be regrouped for display (under symbols) as in legend based on information on the accuracy of the molded product. For example, in case of a determination result of “good” product accuracy, the obtained data group may appear on display in blank circles, and in case of a determination result of “poor” product accuracy, the obtained data group may appear on display in black circles. Determination criteria for the product accuracy are not limited to “good” and “poor,” but further scales may be added and displayed separately for each legend depending on circumstances. Information on the product accuracy corresponding to each load value data, if associated in advance with the number of shots of the press machine 1 (the value of the production number counter of the press machine 1) and stored in the storage unit 103, can also be associated with each eccentric load data. The quality determination of the product accuracy may be automatically input from an inspection device (not illustrated) to the storage unit 103 in real time during press operation, or a result of a sampling inspection may be manually input to the storage unit 103. The input result of the quality determination is stored in the storage unit 103.

(Approach 3) As shown in FIG. 9, an eccentric load data group may be regrouped for display in increments of arbitrarily set certain length time-lapse as in legend based on information on the time stamp. The data group may be regrouped for display in e.g. 30-minute increments of time-lapse as in legend from start of operation. In the case of producing with a new mold, the load value data may change in a process of shifting from an initial wear after the start of operation (a state in which fine irregularities of a member are removed) to a subsequent steady wear. Even in such a case, regrouping for display in increments of time-lapse can facilitate to recognize a temporal change in the eccentric load, and to select the eccentric load data after a shift to the steady wear.

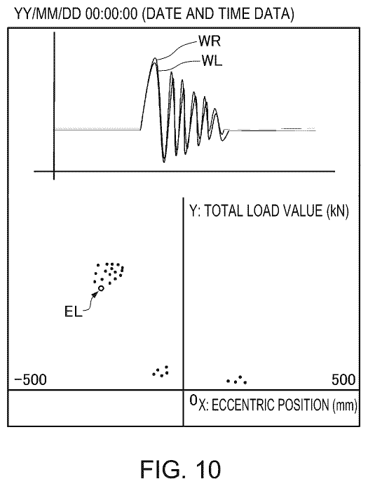

(Approach 4) As shown in FIG. 10, waveform data of the load value corresponding to data arbitrarily selected by the user among the eccentric load data group displayed on the display 120 may appear on the display 120. In the example shown in FIG. 10, the waveform data (the load waveform WR, the load waveform WL) of the load value, which corresponds to an eccentric load EL (indicated in black circles in the figure) arbitrarily selected by the user among the eccentric load data group, is displayed above the image of the eccentric load data group. At this time, a date and time when the data is detected may be displayed together with the waveform data of the load value. In this way, the user can determine based on the waveform of each data of the eccentric load which data is to be included in the range R representing a normal distribution.

According to the above method, criteria for determination in specifying the range R can be given to the user, and the user can easily determine later which data should be specified as the range R representing a normal distribution.

Next, the control device 100 determines whether or not to continue the process (to generate normal distribution data of an eccentric load corresponding to another mold number) (step S20), and in a case where the process is continued (Y in step S20), the process proceeds to step S14.

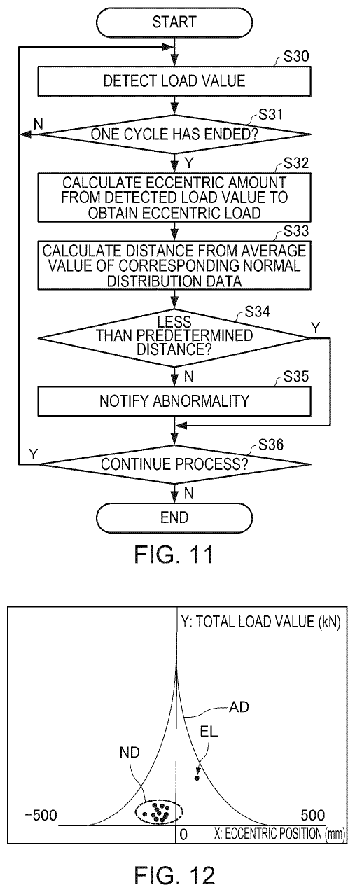

FIG. 11 is a flowchart illustrating a flow of process of detecting an abnormality. The abnormality is detected during normal press operation.

First, the detection unit 102 receives the data output from the right load sensor 30 and the data output from the left load sensor 31, converts the received data based on the calibration data stored in storage unit 103, and detects the converted data as a load value (step S30). Next, the control device 100 determines whether or not one cycle of press has ended based on the information of the current crank angle (step S31), and in case of one cycle still ongoing (N in step S31), the process proceeds to step S30 and the detection of the load value is continued. In a case of one cycle ended (Y in step S31), the calculation unit 104 calculates the eccentric amount from the detected load value for one cycle (the waveform data of the right load and the waveform data of the left load) to obtain the eccentric load (a pair of the total load value and the eccentric amount) (step S32).

Next, the determination unit 105 makes use of an average value and a standard deviation σ of the normal distribution data of the eccentric load corresponding to the mold number of the mold attached to the slide 17 and the bolster 18 of the press machine 1 during detection of the load value in step S30 among the normal distribution data of the eccentric load for each mold stored in the storage unit 103, to obtain a distance (a deviation) of the eccentric load obtained in step S32 from the average value (step S33), and to determine whether the distance is within a predetermined distance (step S34). In case of deviation of the eccentric load obtained in step S32 by a predetermined distance (for example, 30 to 60) or more from the average value of the normal distribution data (N in step S34), the notification unit 106 notifies an abnormality (step S35).

Next, the control device 100 determines whether or not to continue the process of detecting an abnormality (step S36), and in a case where the process is continued (Y in step S36), the process proceeds to step S30, and thereafter, an abnormality is detected based on the eccentric load obtained for each press cycle.

According to the present embodiment, the load value detected by the detection unit 102 is stored in advance in association with the mold number of the mold attached to the slide 17 and the bolster 18 of the press machine 1 during detection of the load value, the eccentric load is obtained from the stored load value to generate the normal distribution data of the eccentric load for each mold, and the abnormality is determined based on the eccentric load obtained on the basis of the load value detected by the detection unit 102 during press operation and the normal distribution data of the eccentric load corresponding to the mold attached to the slide 17 and the bolster 18 of the press machine 1 during detection of the load value, whereby the abnormality in the mold can be detected. For example, as shown in FIG. 12, in case of deviation of the eccentric load EL based on the load value detected during press operation by a predetermined distance or more from the average value of a normal distribution ND of the eccentric load during normal time, which is attributable to an abnormality in the mold or a defect in the product accuracy, it is possible to detect an abnormality even when the eccentric load EL is within the range of an allowable eccentric load diagram AD. On the other hand, in the conventional method, an abnormality cannot be detected as long as the eccentric load EL is within the range of the allowable eccentric load diagram AD. Further, according to the present embodiment, data in a range arbitrarily specified by the user among an eccentric load data group corresponding to the same mold is defined as normal distribution data of the eccentric load corresponding to the mold, so that it is possible to create proper normal distribution data of the eccentric load by excluding the eccentric load data based on the load value detected during passage of the material into the mold or during idling.

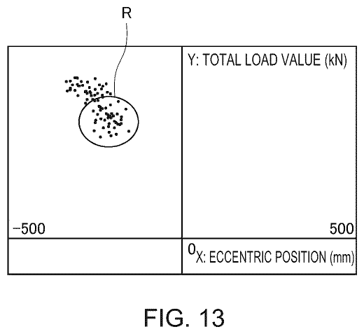

Further, in the present embodiment, it is possible to estimate a change in the mold from the change in the distribution of the eccentric load corresponding to the same mold. For example, in a case where the normal distribution of the eccentric load immediately after a maintenance of the mold is the distribution within the range R shown in FIG. 6 and the distribution of the eccentric load corresponding to the same mold after several tens of thousands of shots is the distribution shown in FIG. 13, the distribution of the eccentric load tends to move in an upper left direction, so it is estimated that progress of wear in a punch and a die on an upstream side of the mold and some abnormality have occurred. In this way, it is possible to quickly detect a change and an abnormality in the mold from the change in the distribution of the eccentric load corresponding to the same mold, and it is possible to perform mold maintenance at an optimal timing.

In the above example, a case where the distribution data of the eccentric load is the normal distribution data, and the distance (deviation) from the average value of the normal distribution data to a target is calculated to determine an abnormality has been described, but the method of abnormality determination is not limited thereto. For example, the Mahalanobis-Taguchi (MT) method may be used to determine an abnormality by calculating the distance of Mahalanobis from the center of a unit space to the target using the distribution data of the eccentric load (a plurality of eccentric load data selected by the user among an eccentric load data group corresponding to the same mold) as the unit space.

Note that, JP-A-2016-209887 discloses a calculation method for creating an allowable load diagram (corresponding to AD in FIG. 12) in a two-point drive press machine, which has long been a well-known method among those skilled in the art. In the allowable eccentric load diagram created by this calculation method the only limiting factor is point capability, and an influence of an inclination of the slide and the like are not considered. For this reason, even when the press machine is used with a load below an allowable value of the eccentric load, there is a concern about occurrence of defects such as deterioration of product accuracy due to the inclination of the slide, seizure of a slide guide, damage of the mold, and damage of the frame and the point of the press machine. In order to avoid the occurrence of such defects, each press manufacturer creates a combined allowable load diagram in consideration of a safety factor and a limitation of an inclination amount of the slide based on the limitation of the point ability, and gives the diagram to the user.

Although embodiments of the present invention have been described in detail as described above, those skilled in the art can easily understand that many variations can be made without departing from the novelties and effects of the present invention.

What is claimed is:

1. A press machine comprising:
a detection unit that detects a load value during press process on a material to be processed;
a storage unit that stores the load value detected by the detection unit in association with identification information of a mold attached to the press machine during detection of the load value;
a calculation unit that calculates a position of a load center acting on the press machine based on the stored load value, calculates the position of the load center as an eccentric amount from a center of the press machine to obtain an eccentric load, and generates distribution data of the eccentric load for each mold;
a determination unit that determines an abnormality based on the eccentric load obtained on the basis of the load value detected by the detection unit and the distribution data of the eccentric load corresponding to the mold attached to the press machine during the detection of the load value; and
a notification unit that notifies an abnormality based on a determination result of the determination unit.

2. The press machine according to claim 1, wherein
in the calculation unit,
a plurality of eccentric load data arbitrarily selected by a user among an eccentric load data group corresponding to the same mold is defined as distribution data of the eccentric load corresponding to the mold.

3. The press machine according to claim 2, further comprising a display control unit that causes a display unit to display an image in which an eccentric load data group corresponding to the same mold is plotted.

4. The press machine according to claim 3, wherein
the display control unit causes the display unit to display waveform data of a load value corresponding to data arbitrarily selected by a user among the data group displayed on the display unit.

5. An abnormality detection method for a press machine comprising:
a detection step of detecting a load value during press process on a material to be processed;
a storage step of storing the load value detected in the detection step in association with identification information of a mold attached to the press machine during detection of the load value;
a calculation step of calculating a position of a load center acting on the press machine based on the stored load value, calculating the position of the load center as an eccentric amount from a center of the press machine to obtain an eccentric load, and generating distribution data of the eccentric load for each mold;
a determination step of determining an abnormality based on the eccentric load obtained on the basis of the load value detected in the detection step and the distribution data of the eccentric load corresponding to the mold attached to the press machine during the detection of the load value; and
a notification step of notifying an abnormality based on a determination result of the determination step.
